(19) United States
(12) Patent Application Publication
(10) Pub. No.: US 2025/0390683 A1
(43) Pub. Date: Dec. 25, 2025

(54) METHOD FOR TRAINING TEXT QUESTION AND ANSWER MODEL, AND ELECTRONIC DEVICE

(71) Applicant: BEIJING BAIDU NETCOM SCIENCE TECHNOLOGY CO., LTD., Beijing (CN)

(72) Inventors: Xinran He, Beijing (CN); Bolei He, Bejing (CN)

(73) Assignee: BEIJING BAIDU NETCOM SCIENCE TECHNOLOGY CO., LTD., Beijing (CN)

(21) Appl. No.: 18/979,322

(22) Filed: Dec. 12, 2024

(30) Foreign Application Priority Data
Jun. 20, 2024 (CN) 2024108008486

(51) Int. Cl. G06F 40/35

(52) U.S. Cl. CPC G06F 40/35

(57) ABSTRACT

A method for training a text question and answer (Q&A) model is performed by an electronic device. The method includes: determining a sample question text set and a sample answer text corresponding to a sample question text in the sample question text set; inputting the sample question text into a text Q&A model to be trained, and obtaining a predicted answer text output by the text Q&A model and at least one prediction probability of at least one reference character on each character position in the predicted answer text; determining an uncertainty degree of the predicted answer text; and obtaining a trained text Q&A model by adjusting a parameter of the text Q&A model based on the sample answer text, the predicted answer text and the uncertainty degree of the predicted answer text.

### CROSS-REFERENCE TO RELATED APPLICATION

The present application is based upon and claims priority to Chinese Patent Application No. 2024108008486, filed on Jun. 20, 2024, the entire contents of which are incorporated herein by reference.

### TECHNICAL FIELD

The present disclosure relates to the technical field of artificial intelligence, in particular to the technical fields of deep learning, natural language processing, etc., and in particular to a method and an apparatus for training a text question and answer (Q&A) model, and an electronic device.

### BACKGROUND

At present, the method for training a text question and answer (Q&A) model mainly includes: determining a question text set and an answer corresponding to each question text in the question text set; and obtaining a trained Q&A model by training and processing the Q&A model based on the answer corresponding to each question text in the question text set.

In the above solution, in the training process of the Q&A model, since some question texts are relatively simple and some question texts are relatively difficult, it is difficult for the Q&A model to learn well about some question texts, resulting in a poor training efficiency of the Q&A model.

### SUMMARY

According to a first aspect of the present disclosure, a computer-implemented method for training a text Q&A model is provided, including: determining a sample question text set and a sample answer text corresponding to a sample question text in the sample question text set; inputting the sample question text into a text Q&A model to be trained, and obtaining a predicted answer text output by the text Q&A model and at least one prediction probability of at least one reference character on each character position in the predicted answer text; determining an uncertainty degree of the predicted answer text based on the prediction probability of at least one reference character on each character position in the predicted answer text; and obtaining a trained text Q& A model by adjusting a parameter of the text Q&A model based on the sample answer text, the predicted answer text and the uncertainty degree of the predicted answer text.

According to a second aspect of the present disclosure, an electronic device is provided, including: at least one processor; and a memory connected in communication with the at least one processor, in which the memory stores instructions executable by the at least one processor. When the instructions are executed by the at least one processor, the at least one processor is caused to implement the above method described in the first aspect.

According to a third aspect of the present disclosure, a non-transitory computer-readable storage medium for storing computer instructions is provided, in which the computer instructions are configured to cause a computer to implement the above method described in the first aspect.

### BRIEF DESCRIPTION OF THE DRAWINGS

The accompanying drawings are used for a better understanding of the disclosure and do not constitute a limitation of the disclosure.

FIG. 1 is a schematic diagram according to a first embodiment of the present disclosure.

FIG. 2 is a schematic diagram according to a second embodiment of the present disclosure.

FIG. 3 is a schematic diagram according to a third embodiment of the present disclosure.

FIG. 4 is a schematic diagram according to a fourth embodiment of the present disclosure.

FIG. 5 is a schematic diagram according to a fifth embodiment of the present disclosure.

FIG. 6 is a schematic diagram according to a sixth embodiment of the present disclosure.

FIG. 7 is a block diagram of an electronic device configured to implement a method for training a text question and answer (Q&A) model in embodiments according to an the present disclosure.

### DETAILED DESCRIPTION

Exemplary embodiments of the disclosure are described hereinafter in conjunction with the accompanying drawings, which include various details of the embodiments of the disclosure in order to aid in understanding, and should be considered exemplary only. Accordingly, one of ordinary skill in the art should recognize that various changes and modifications may be made to the embodiments described herein without departing from the scope of the disclosure. Similarly, descriptions of well-known features and structures are omitted from the following description for the sake of clarity and brevity.

At present, the method for training a text question and answer (Q&A) model mainly includes: determining a question text set and an answer corresponding to each question text in the question text set; and obtaining a trained Q&A model by training and processing the Q&A model based on the answer corresponding to each question text in the question text set.

In the above solution, in the training process of the Q&A model, since some question texts are relatively simple and some question texts are relatively difficult, it is difficult for the Q&A model to learn well about some question texts, resulting in a poor training efficiency of the Q&A model.

In order to overcome the above problem in the related art, the embodiments of the present disclosure provide a method and an apparatus for training a text Q&A model, and an electronic device.

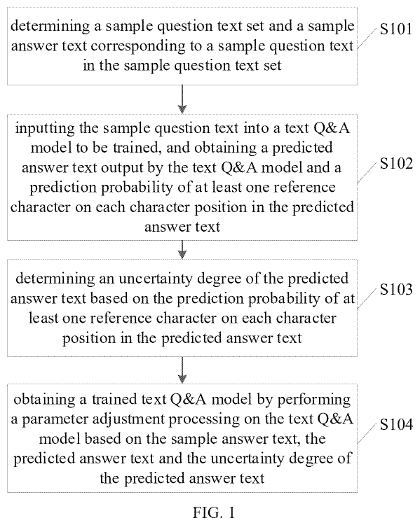

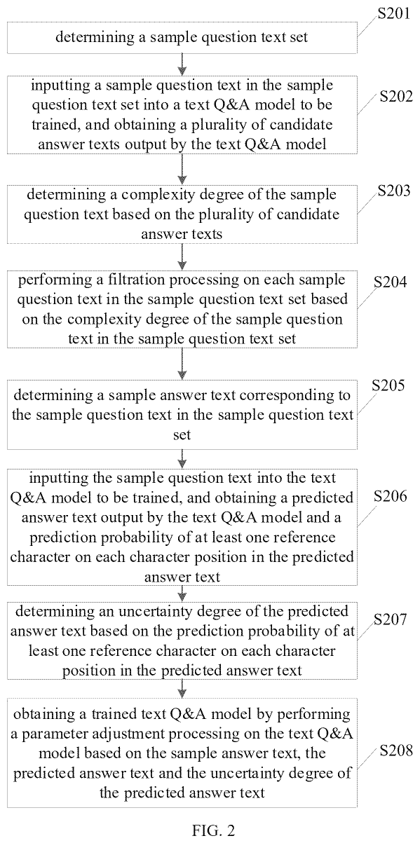

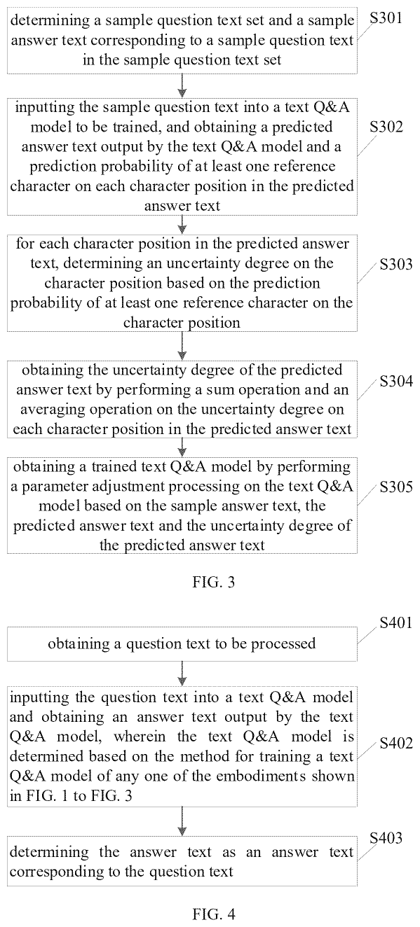

FIG. 1 is a schematic diagram according to a first embodiment of the present disclosure. It should be noted that the method for training a text Q&A model in the embodiments of the present disclosure may be applied to an apparatus for training a text Q&A model. The apparatus is configured in an electronic device so that the electronic device may perform a function for training a text Q&A model.

The electronic device may be any device having computing power, which may be, for example, a personal computer (PC), a mobile terminal, a server, etc. The mobile terminal may be, for example, a hardware device having various operating systems, touch screens, and/or displays, such as an in-vehicle/vehicle-mounted device, a cellular phone, a tablet computer, a personal digital assistant, a wearable device, a smart speaker, a server, a server cluster, etc.

The apparatus for training a text Q&A model may also be a software application in an electronic device, such as a software application for training a text Q&A model. In the following embodiments, the apparatus for training a text Q&A model being the electronic device is taken as an example.

As shown in FIG. 1, the method for training a text Q&A model may include the following steps 101 to 104.

At step 101, a sample question text set and a sample answer text corresponding to a sample question text in the sample question text set are determined.

In the embodiments of the disclosure, in one example, the process that the electronic device determines the sample answer text corresponding to the sample question text in the sample question text set may for example be: for the sample question text in the sample question text set, obtaining an answer text output by a teacher text Q&A model by inputting the sample question text into the teacher text Q&A model; and taking the answer text output by the teacher text Q&A model as the sample answer text corresponding to the sample question text.

The structure of the teacher text Q&A model and the structure of the text Q& A model may be the same or different. A number of parameters in the teacher text Q&A model may be much larger than a number of parameters in the text Q&A model. The teacher text Q&A model may be trained based on more than a preset number of Q&A pairs.

The teacher text Q&A model has a large number of parameters with a large amount of calculation. The sample answer text obtained based on the teacher text Q&A model is with a high accuracy, which further improves the training efficiency of the text Q&A model.

In another example, the process that the electronic device determines the sample answer text corresponding to the sample question text in the sample question text set may for example be: for the sample question text in the sample question text set, obtaining a reference question text matching the sample question text in a Q&A database by inquiring the Q& A database based on the sample question text; and determining a reference answer text corresponding to a matched reference question text in the Q&A database as the sample answer text corresponding to the sample question text.

In another example, the process that the electronic device determines the sample answer text corresponding to the sample question text in the sample question text set may for example be: providing the sample question text to an object via an interaction device, and obtaining an answer text returned by the interaction device; and taking the answer text returned by the interaction device as the sample answer text corresponding to the sample question text.

It should be noted that at least two of the above three examples are combined to determine the sample answer text corresponding to the sample question text. For example, part of the sample question text is determined based on one of the examples, and part of the sample question text is determined based on another one of the examples. For another example, for a specific sample question text, the sample answer text corresponding to the sample question text is determined by combining the sample answer texts determined based on at least two examples; for another specific sample question text, the sample answer text is determined based on one of the examples.

At step 102, the sample question text is input into a text Q&A model to be trained, and a predicted answer text output by the text Q&A model and a prediction probability of at least one reference character on each character position in the predicted answer text are obtained.

In the embodiments of the present disclosure, each reference character may be a character in a character list in the text Q&A model. For each sample question text to be processed, the text Q&A model may select each reference character for each character position from the character list. Then the predicted answer text is generated by combining reference characters selected at each character position.

Assuming that the character list includes four characters, that is, character A, character B, character C, and character D. For each character position in the predicted answer text, a prediction probability of character A, a prediction probability of character B, a prediction probability of character C and a prediction probability of character D may be determined by the text Q&A model. The sum of predicted probabilities of all characters at that character position is equal to 1.

At step 103, an uncertainty degree of the predicted answer text is determined based on the prediction probability of at least one reference character on each character position in the predicted answer text.

In the embodiments of the present disclosure, the uncertainty degree reflects a difficulty degree of the text Q&A model in predicting the answer text. For example, when the text Q&A model generates the predicted answer text for some sample question text, it is difficult to determine which reference character is selected on the character position of the predicted answer text, that is, the prediction probability of each reference character has little difference, and the calculated uncertainty degree of the predicted answer text is huge, which means that the text Q&A model is difficult to predict the predicted answer text. When the text Q&A model generates the predicted answer text for some sample question text, it is easy to determine which reference character is selected on the character position of the predicted answer text, that is, the prediction probability of each reference character is quite different, and it is easy to select the required reference character from the reference characters. In this case, the calculated uncertainty degree of the predicted answer text is small, which means that the text Q&A model has little difficulty in predicting the answer text.

At step 104, a trained text Q&A model is obtained by performing a parameter adjustment processing on the text Q&A model based on the sample answer text, the predicted answer text and the uncertainty degree of the predicted answer text.

In the embodiments of the present disclosure, the process that electronic device performs step 104 may for example be: determining a first loss value based on the sample answer text, the predicted answer text and a loss function of the text Q&A model; obtaining a second loss value by performing an adjustment processing on the first loss value based on the uncertainty degree of the predicted answer text; and obtaining the trained text Q&A model by performing the parameter adjustment processing on the text Q&A model based on the second loss value.

The process that the electronic device determines the second loss value by may for example be: obtaining an adjustment coefficient by performing a weighting processing on the uncertainty degree of the predicted answer text with a preset coefficient and adding 1 to the uncertainty degree weighted; and obtaining the second loss value by performing the adjustment processing on the first loss value based on the adjustment coefficient.

Specifically, the electronic device may obtain a product result by performing a product operation on the adjustment coefficient and the first loss value; and determine the product result as the second loss value.

It should be noted that when the text Q&A model determines the second loss value, generally, the second loss value may be determined based on a batch of sample question texts. In this case, the electronic device may determine the adjustment coefficient based on uncertainty degrees of a plurality of predicted answer texts. For example, the electronic device may obtain an average result by performing an averaging operation on the uncertainty degrees of the plurality of predicted answer texts, and obtain the adjustment coefficient by performing the weighting processing on the average result with the preset coefficient and adding 1 to the average result weighted.

The formula for calculating the second loss value is shown in the following formula (1)

$${L}_{2}^{*} = {L}_{2} ( 1 + α {E}_{{pred}_{norm}} ) \qquad ( 1 )$$

where Ly represents the second loss value, L₂ represents the first loss value, a represents the preset coefficient, and E_{pred}_{ₙₒᵣₘ} represents the average value of the uncertainty degrees of the plurality of predicted answer texts.

When the uncertainty degree of the predicted answer text is large, it means that the text Q&A model has large difficult to predict the predicted answer text, and the text Q&A model may adjust the model parameters with a large margin based on the predicted answer text. When the uncertainty degree of the predicted answer text is small, it means that the text Q&A model has little difficulty in predicting the predicted answer text, and the text Q&A model may adjust the model parameter with a small margin based on the predicted answer text. Therefore, the adjustment coefficient is determined based on the uncertainty degree of the predicted answer text, then the second loss function is determined based on the adjustment coefficient and the first loss function, and the parameter adjustment processing is performed on the text Q&A model, which makes the text Q&A model focus on learning the predicted answer text with the large uncertainty degree and the corresponding sample question text, and further improves the training efficiency of the text Q& A model.

According to the method for training a text Q&A model in embodiments of the disclosure, the sample question text set and the sample answer text corresponding to the sample question text in the sample question text set are determined; the sample question text is inputted into the text Q& A model to be trained, and the predicted answer text output by the text Q&A model and the prediction probability of at least one reference character on each character position in the predicted answer text are obtained; the uncertainty degree of the predicted answer text is determined based on the prediction probability of at least one reference character on each character position in the predicted answer text; and the trained text Q&A model is obtained by performing the parameter adjustment processing on the text Q&A model based on the sample answer text, the predicted answer text and the uncertainty degree of the predicted answer text. Performing the parameter adjustment processing on the text Q&A model based on the uncertainty degree of the predicted answer text makes the text Q&A model focus on learning the predicted answer text with the large uncertainty degree and the corresponding sample question text, which further improves the training efficiency of the text Q&A model.

In order to further improve the training efficiency of the text Q&A model, the electronic device may perform a filtration processing on a relatively simple sample question text in the sample question text set, so that the text Q&A model may focus on learning a more complex sample question text in the sample question text set. As shown in FIG. 2, which is a schematic diagram according to a second embodiment of the present disclosure, the embodiments shown in FIG. 2 may include the following steps 201 to 208.

At step 201, a sample question text set is determined.

At step 202, the sample question text in the sample question text set is input into the text Q&A model to be trained, and a plurality of candidate answer texts output by the text Q&A model are obtained.

In the embodiments of the present disclosure, for each sample question text in the sample question text set, the electronic device may input the sample question text into the text Q& A model for a plurality of times, and obtain a plurality of candidate answer texts output by the text Q&A model. When the electronic device inputs the sample question text into the text Q&A model for the plurality of times, the plurality of candidate answer texts output by the text Q&A model may be the same or different. In the case of at least two same candidate answer texts existing in the plurality of candidate answer texts, the same candidate answer texts may be deduplicated.

At step 203, a complexity degree of the sample question text is determined based on the plurality of candidate answer texts.

In the embodiments of the present disclosure, the process that the electronic device performs step 203 may for example be: obtaining at least two clusters by performing a cluster processing on the plurality of candidate answer texts; determining an occurrence probability of a candidate answer text in the at least two clusters; and determining the complexity degree of the sample question text based on the occurrence probability of the candidate answer text in the at least two clusters.

In one example, the process that the electronic device performs the cluster processing on the plurality of candidate answer texts may for example be: obtaining a plurality of answer text vectors for the plurality of candidate answer texts by performing a vectorization processing on the plurality of candidate answer texts; determining a similarity degree among the plurality of answer text vectors; and obtaining the at least two clusters by performing a cluster processing on the plurality of candidate answer texts corresponding to the plurality of answer text vectors based on the similarity degree among the plurality of answer text vectors.

Specifically, for any two answer text vectors, the electronic device may add the candidate answer texts corresponding to the two answer text vectors to the same cluster when the similarity degree between the two answer text vectors is greater than or equal to a first similarity degree threshold; the electronic device may add the candidate answer texts corresponding to the two answer text vectors to different clusters when the similarity degree between the two answer text vectors is less than or equal to a second similarity degree threshold.

Based on the similarity degree among the plurality of answer text vectors, the cluster processing is performed on the candidate answer texts corresponding to the plurality of answer text vectors, which may ensure that the similarity degree among the candidate answer texts in the same cluster is large enough, and improve the accuracy of the obtained cluster.

In another example, the process that the electronic device performs the cluster processing on the plurality of candidate answer texts may for example be: extracting keywords of the plurality of candidate answer texts; for any two candidate answer texts, determining whether to add the two candidate answer texts to the same cluster based on a number and/or a proportion of the same keywords in the two candidate answer texts. For example, when the number of the same keywords in the two candidate answer texts is greater than a certain threshold, and/or the proportion of the same keywords in the two candidate answer texts is greater than a certain percentage threshold, it is determined that the two candidate answer texts are added to the same cluster.

In the embodiments of the present disclosure, the process that the electronic device determines the complexity degree of the sample question text based on the occurrence probability of the candidate answer text in the at least two clusters may for example be: for each cluster, determining a product result of a logarithm of the occurrence probability of the candidate answer text in the cluster and the occurrence probability of the candidate answer text in the cluster; and obtaining the complexity degree of the sample question text by performing a sum operation and a NOT operation on each product result.

The formula for calculating the complexity degree of the sample question text may be shown in the following formula (2), for example.

$${E}_{sem} ( x ) = - {\sum }_{c} p ( c \vert x ) log p ( c \vert x ) = - {\sum }_{c} ( {\sum }_{s ∈ c} p ( s \vert x ) ) log ( {\sum }_{s ∈ c} p ( s \vert x ) ) \qquad ( 2 )$$

where Eₛₑₘ(x) represents the complexity degree of the sample question text,

$${\sum }_{c} p ( c \vert x )$$

represents the probability of generating the candidate answer text in c when x is an input, x represents the sample question text; c represents a cluster, p(s|x) represents the probability of generating s when x is the input, and s represents one of the candidate answer texts in the cluster.

The occurrence probability of candidate answer texts in each cluster reflects the distribution of the plurality of candidate answer texts corresponding to the sample question text, and then determines the capability of the text Q&A model to provide an answer text based on the sample question text. Therefore, based on the occurrence probability of candidate answer texts in each cluster, the complexity degree of the sample question text may be accurately determined.

At step 204, a filtration processing is performed on each sample question text in the sample question text set based on a complexity degree of the sample question text in the sample question text set.

In the embodiments of the present disclosure, in one example, the process that the electronic device performs step 204 may for example be: when the complexity degree of the sample question text is less than or equal to the preset complexity degree threshold, the deletion processing is performed on the sample question text in the sample question text set; and when the complexity degree of the sample question text is greater than the preset complexity degree threshold, the retention processing is performed on the sample question text in the sample question text set.

Performing the deletion processing on the sample question text whose complexity degree is less than or equal to the preset complexity degree threshold may ensure that the complexity degree of each sample question text in the sample question text set is high enough and ensure that all the sample question texts in the sample question text set are the sample question texts that the text Q&A model needs to learn, and further improve the training efficiency of the text Q& A model.

In the embodiments of the present disclosure, in another example, the process that the electronic device performs step 204 may for example be: obtaining a ranking result by performing a ranking processing on each sample question text in descending order based on the complexity degree of each sample question text; obtaining a preset number of first sample question texts that rank in the top of the ranking result; and performing a filtration processing on sample question texts in the sample question text set except the first sample question texts.

The ranking processing is performed on each sample question text based on the complexity degree of each sample question text, and then a plurality of sample question texts with the higher complexity degree are obtained, which may ensure that the complexity degree of each sample question text in the sample question text set is high enough, and further improve the training efficiency of the text Q&A model.

At step 205, a sample answer text corresponding to a sample question text in the sample question text set is determined.

At step 206, the sample question text is input into a text Q&A model to be trained, and a predicted answer text output by the text Q&A model and a prediction probability of at least one reference character on each character position in the predicted answer text are obtained.

At step 207, an uncertainty degree of the predicted answer text is determined based on the prediction probability of at least one reference character on each character position in the predicted answer text.

At step 208, a trained text Q&A model is obtained by performing a parameter adjustment processing on the text Q&A model based on the sample answer text, the predicted answer text and the uncertainty degree of the predicted answer text.

It should be noted that the details of step 201, and steps 205 to 208 may be referred to the above steps 101 to 104 in the embodiments shown in FIG. 1, which will not be described in detail here.

According to the method for training a text Q&A model in embodiments of the disclosure, the sample question text set is determined; the sample question text in the sample question text set is input into the text Q&A model to be trained, and the plurality of candidate answer texts output by the text Q&A model are obtained; the complexity degree of the sample question text is determined based on the plurality of candidate answer texts; the filtration processing is performed on each sample question text in the sample question text set based on the complexity degree of the sample question text in the sample question text set; the sample answer text corresponding to the sample question text in the sample question text set is determined; the sample question text is inputted into the text Q&A model to be trained, and the predicted answer text output by the text Q&A model and the prediction probability of at least one reference character on each character position in the predicted answer text are obtained; the uncertainty degree of the predicted answer text is determined based on the prediction probability of at least one reference character on each character position in the predicted answer text; and the trained text Q&A model is obtained by performing the parameter adjustment processing on the text Q&A model based on the sample answer text, the predicted answer text and the uncertainty degree of the predicted answer text. The filtration processing performed on the relatively simple sample question text in the sample question text set may ensure that the complexity degree of the sample question text in each sample question text set is high enough and ensure that all the sample question texts in the sample question text set are the sample question texts that the text Q&A model needs to learn, and further improve the training efficiency of the text Q&A model.

In order to further improve the training efficiency of the text Q&A model, in the process of determining the uncertainty degree of the predicted answer text, the uncertainty degrees on each character position are first determined, and then the uncertainty degree of the predicted answer text is determined. As shown in FIG. 3, which is a schematic diagram according to a third embodiment of the present disclosure, the embodiments shown in FIG. 3 may include the following steps 301 to 305.

At step 301, a sample question text set and a sample answer text corresponding to a sample question text in the sample question text set are determined.

At step 302, the sample question text is input into a text Q&A model to be trained, and a predicted answer text output by the text Q&A model and a prediction probability of at least one reference character on each character position in the predicted answer text are obtained.

At step 303, for each character position in the predicted answer text, an uncertainty degree on the character position is determined based on the prediction probability of at least one reference character on the character position.

In the embodiments of the present disclosure, the process that the electronic device performs step 303 may for example be: for each reference character on each character position in the predicted answer text, determining a product result of a logarithm of a prediction probability of the reference character and the prediction probability of the reference character; and obtaining the uncertainty degree on the character position by performing a sum operation and a NOT operation on each product result.

The prediction probability of each reference character on the character position may reflect the distribution of each reference character on the character position, and then determine the capability of the text Q&A model to provide the predicted character on the character position based on the sample question text. Therefore, based on the prediction probability of each reference character on the character position, the uncertainty degree on the character position may be accurately determined.

For example, assuming that there are 4 reference characters on the character position and the prediction probabilities of the 4 reference characters are all 25%, it means that it is difficult for the text Q&A model to select the predicted character on the character position from the 4 reference characters based on the sample question text, and the uncertainty degree on the character position is large. If the prediction probability of one of the 4 reference characters is 97% and the prediction probabilities of other three reference characters are all 1%, it means that the text Q&A model may easily select the predicted character on the character position from the 4 reference characters based on the sample question text, and the uncertainty degree on the character position is small.

At step 304, the uncertainty degree of the predicted answer text is obtained by performing a sum operation and an averaging operation on the uncertainty degree on each character position in the predicted answer text.

In the embodiments of the present disclosure, the formula for calculating the uncertainty degree of the predicted answer text is shown in the following formula (3).

$${E}_{pred} = \frac{1}{M - m} {\sum }_{t = m + 1}^{M} {\sum }_{i = 1}^{K} {P}_{ti} log {P}_{ti} \qquad ( 3 )$$

where E_{pred} represents the uncertainty degree of the predicted answer text, M represents a total number of characters in the sample question text and characters in the predicted answer text, m represents a number of characters in the sample question text, M−m represents a number of characters in the predicted answer text, K represents a total number of reference characters on one character position, t represents the character position, and Pₜᵢ represents the prediction probability of the reference character i on the character position t.

At step 305, a trained text Q&A model is obtained by performing a parameter adjustment processing on the text Q&A model based on the sample answer text, the predicted answer text and the uncertainty degree of the predicted answer text.

It should be noted that the details of steps 301 to 302, and step 305 may be referred to the above steps 101 to 102, and step 104 in the embodiments shown in FIG. 1, which will not be described in detail here.

According to the method for training a text Q&A model in embodiments of the disclosure, the sample question text set and the sample answer text corresponding to the sample question text in the sample question text set are determined; the sample question text is inputted into the text Q& A model to be trained, and the predicted answer text output by the text Q&A model and the prediction probability of at least one reference character on each character position in the predicted answer text are obtained; for each character position in the predicted answer text, the uncertainty degree on the character position is determined based on the prediction probability of at least one reference character on the character position; the uncertainty degree of the predicted answer text is obtained by performing the sum operation and the averaging operation on the uncertainty degree on each character position in the predicted answer text; and the trained text Q&A model is obtained by performing the parameter adjustment processing on the text Q&A model based on the sample answer text, the predicted answer text and the uncertainty degree of the predicted answer text. The uncertainty degree on the character position is determined based on the prediction probability of at least one reference character on the character position, and then the uncertainty degree of the predicted answer text is determined, which further improves the efficiency of the text Q&A model learning the predicted answer text with the high uncertainty degree and the corresponding sample question text, and further improves the training efficiency of the text Q&A model.

FIG. 4 is a schematic diagram according to a fourth embodiment of the present disclosure. It should be noted that the method for training a text Q&A model in the embodiments of the present disclosure may be applied to an apparatus for training a text Q&A model. The apparatus is configured in an electronic device so that the electronic device may perform a text Q& A function.

The electronic device may be any device having computing power, which may be, for example, a PC, a mobile terminal, a server, etc. The mobile terminal may be, for example, a hardware device having various operating systems, touch screens, and/or displays, such as an in-vehicle/vehicle-mounted device, a cellular phone, a tablet computer, a personal digital assistant, a wearable device, a smart speaker, a server, a server cluster, etc.

The apparatus for training a text Q&A model may also be a software application in an electronic device, such as a software application for training a text Q&A model. In the following embodiments, the apparatus for training a text Q&A model being the electronic device is taken as an example.

As shown in FIG. 4, the text Q&A method may include the following steps 401 to step 403.

At step 401, a question text to be processed is obtained.

At step 402, the question text is input into a text Q&A model and an answer text output by the text Q&A model is obtained, in which the text Q&A model is determined based on the method for training a text Q&A model of any one of the embodiments from the embodiment shown in FIG. 1 to the embodiment shown in FIG. 3.

In the embodiments of the present disclosure, the text Q&A model may be obtained by performing the parameter adjustment processing on the sample answer text, the predicted answer text and the uncertainty degree of the predicted answer text. The method for obtaining the predicted answer text includes: inputting the sample question text corresponding to the sample answer text into the text Q&A model, and obtaining the predicted answer text output by the text Q&A model. The text Q&A model may also output the prediction probability of at least one reference character at each character position in the predicted answer text. The prediction probability of at least one reference character at each character position in the predicted answer text is used to determine the uncertainty degree of the predicted answer text.

At step 403, the answer text is determined as an answer text corresponding to the question text.

According to the method for text Q&A model in embodiments of the disclosure, the question text to be processed is obtained; the question text is input into the text Q&A model and the answer text output by the text Q&A model is obtained; and the output answer text is determined as the answer text corresponding to the question text. The text Q&A model is trained based on the sample answer text corresponding to the sample question text, the predicted answer text and the uncertainty degree of the predicted answer text. Thus in the training process, the model in the disclosure may focus on learning the predicted answer text with the large uncertainty degree and the corresponding sample question text, which improves the Q&A accuracy of the text Q& A model and improves the matching degree between the determined answer text and the question text.

In order to implement the above embodiments, the present disclosure also provides an apparatus for training a text Q&A model. As shown in FIG. 5, which is a schematic diagram according to a fifth embodiment of the present disclosure, the apparatus 50 for training a text Q&A model may include: a first determining module 501, a first obtaining module 502, a second determining module 503 and a training module 504.

The first determining module 501 is configured to determine a sample question text set and a sample answer text corresponding to a sample question text in the sample question text set; the first obtaining module 502 is configured to input the sample question text into a text Q&A model to be trained, and obtain a predicted answer text output by the text Q&A model and a prediction probability of at least one reference character on each character position in the predicted answer text; the second determining module 503 is configured to determine an uncertainty degree of the predicted answer text based on the prediction probability of at least one reference character on each character position in the predicted answer text; and the training module 504 is configured to obtain a trained text Q&A model by performing a parameter adjustment processing on the text Q& A model based on the sample answer text, the predicted answer text and the uncertainty degree of the predicted answer text.

As a possible implementation of the embodiments of the present disclosure, the apparatus also includes: a second obtaining module, a third determining module and a filter processing module. The second obtaining module is configured to input the sample question text in the sample question text set into the text Q&A model to be trained, and obtain a plurality of candidate answer texts output by the text Q&A model; the third determining module is configured to determine a complexity degree of the sample question text based on the plurality of candidate answer texts; and the filter processing module is configured to perform a filtration processing on each sample question text in the sample question text set based on the complexity degree of the sample question text in the sample question text set.

As a possible implementation of the embodiments of the present disclosure, the third determining module includes: a cluster processing unit, a first determining unit and a second determining unit. The cluster processing unit is configured to obtain at least two clusters by performing a cluster processing on the plurality of candidate answer texts; the first determining unit is configured to determine an occurrence probability of a candidate answer text in the at least two clusters; and the second determining unit is configured to determine the complexity degree of the sample question text based on the occurrence probability of the candidate answer text in the at least two clusters.

As a possible implementation of the embodiments of the present disclosure, the cluster processing unit is specifically configured to obtain a plurality of answer text vectors for the plurality of candidate answer texts by performing a vectorization processing on the plurality of candidate answer texts; determine a similarity degree among the plurality of answer text vectors; and obtain the at least two clusters by performing a cluster processing on the plurality of candidate answer texts corresponding to the plurality of answer text vectors based on the similarity degree among the plurality of answer text vectors.

As a possible implementation of the embodiments of the present disclosure, the second determining unit is specifically configured to, for each cluster, determine a product result of a logarithm of the occurrence probability of the candidate answer text in the cluster and the occurrence probability of the candidate answer text in the cluster; and obtain the complexity degree of the sample question text by performing a sum operation and a NOT operation on each product result.

As a possible implementation of the embodiments of the present disclosure, the filter processing module is specifically configured to perform a deletion processing on the sample question text in the sample question text set, in response to the complexity degree of the sample question text being less than or equal to a preset complexity degree threshold.

As a possible implementation of the embodiments of the present disclosure, the filter processing module is specifically configured to obtain a ranking result by performing a ranking processing on each sample question text in descending order based on the complexity degree of each sample question text; obtain a preset number of first sample question texts that rank in the top of the ranking result; and perform a filtration processing on sample question texts in the sample question text set except the first sample question texts.

As a possible implementation of the embodiments of the present disclosure, the first determining module 501 is specifically configured to, for the sample question text in the sample question text set, obtain an answer text output by a teacher text Q& A model by inputting the sample question text into the teacher text Q&A model; and take the answer text output by the teacher text Q&A model as the sample answer text corresponding to the sample question text.

As a possible implementation of the embodiments of the present disclosure, the second determining module 503 is specifically configured to, for each character position in the predicted answer text, determine an uncertainty degree on the character position based on the prediction probability of at least one reference character on the character position; and obtain the uncertainty degree of the predicted answer text by performing a sum operation and an averaging operation on the uncertainty degree on each character position in the predicted answer text.

As a possible implementation of the embodiments of the present disclosure, the second determining module 503 is further configured to, for each reference character on a character position in the predicted answer text, determine a product result of a logarithm of a prediction probability of the reference character and the prediction probability of the reference character; and obtain the uncertainty degree on the character position by performing a sum operation and a NOT operation on each product result.

As a possible implementation of the embodiments of the present disclosure, the training module 504 is specifically configured to, determine a first loss value based on the sample answer text, the predicted answer text and a loss function of the text Q&A model; obtain a second loss value by performing an adjustment processing on the first loss value based on the uncertainty degree of the predicted answer text; and obtain the trained text Q&A model by performing the parameter adjustment processing on the text Q&A model based on the second loss value.

As a possible implementation of the embodiments of the present disclosure, the training module 504 is further configured to, obtain an adjustment coefficient by performing a weighting processing on the uncertainty degree of the predicted answer text with a preset coefficient and adding 1 to the uncertainty degree weighted; and obtain the second loss value by performing the adjustment processing on the first loss value based on the adjustment coefficient.

According to the apparatus for training a text Q&A model in embodiments of the disclosure, the sample question text set and the sample answer text corresponding to the sample question text in the sample question text set are determined; the sample question text is inputted into the text Q&A model to be trained, and the predicted answer text output by the text Q&A model and the prediction probability of at least one reference character on each character position in the predicted answer text are obtained; the uncertainty degree of the predicted answer text is determined based on the prediction probability of at least one reference character on each character position in the predicted answer text; and the trained text Q&A model is obtained by performing the parameter adjustment processing on the text Q&A model based on the sample answer text, the predicted answer text and the uncertainty degree of the predicted answer text. Performing the parameter adjustment processing on the text Q&A model based on the uncertainty degree of the predicted answer text makes the text Q&A model focus on learning the predicted answer text with the large uncertainty degree and the corresponding sample question text, which further improves the training efficiency of the text Q&A model.

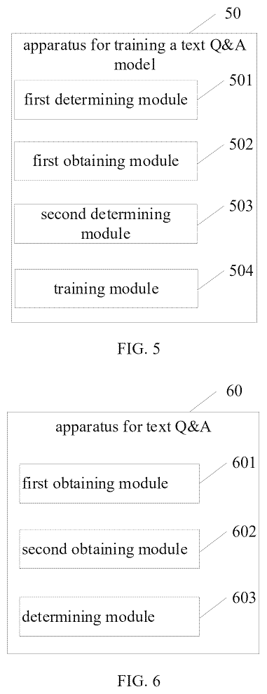

In order to implement the above embodiments, the present disclosure also provides an apparatus for text Q&A. As shown in FIG. 6, which is a schematic diagram according to a sixth embodiment of the present disclosure, the apparatus 60 for text Q&A may include: a first obtaining module 601, a second obtaining module 602 and a determining module 603.

The first obtaining module 601 is configured to obtain a question text to be processed; the second obtaining module 602 is configured to input the question text into a text Q&A model and obtain an answer text output by the text Q&A model, in which the text Q&A model is determined based on the above method for training a text Q&A model; and the determining module 603 is configured to determine the answer text as an answer text corresponding to the question text.

According to the apparatus for text Q&A model in embodiments of the disclosure, the question text to be processed is obtained; the question text is input into the text Q&A model and the answer text output by the text Q&A model is obtained; and the output answer text is determined as the answer text corresponding to the question text. The text Q&A model is trained based on the sample answer text corresponding to the sample question text, the predicted answer text and the uncertainty degree of the predicted answer text. Thus in the training process, the model in the disclosure may focus on learning the predicted answer text with the large uncertainty degree and the corresponding sample question text, which improves the Q&A accuracy of the text Q&A model and improves the matching degree between the determined answer text and the question text.

In the technical solution of the disclosure, the acquisition, storage, application, processing, transmission, provision and disclosure of the personal information of the users are all carried out under the premise of obtaining the consent of the users and are in compliance with relevant laws and regulations, and do not violate public order and morals.

According to embodiments of the disclosure, it also provides an electronic device, a readable storage medium, and a computer program product.

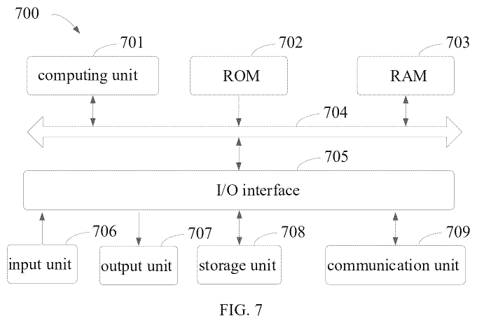

Referring to FIG. 7, it is a block diagram illustrating an electronic device 700 according to an embodiment of the disclosure. The electronic device is intended to represent various types of digital computers, such as laptop computers, desktop computers, workstations, personal digital assistants, servers, blade servers, mainframe computers, and other suitable computers. The electronic device may also represent various types of mobile devices, such as personal digital assistants, cellular phones, smart phones, wearable devices, and other similar computing devices. The components shown herein, their connections and relations, and their functions are merely examples, which are not intended to limit the implementations of the disclosure described and/or required herein.

As shown in FIG. 7, the device 700 includes a computing unit 701, configured to execute various appropriate actions and processes according to a computer program stored in a read-only memory (ROM) 702 or a computer program loaded from a storage unit 708 to a random access memory (RAM) 703. In the RAM 703, various programs and data required for the device 700 may be stored. The computing unit 701, the ROM 702 and the RAM 703 may be connected with each other by a bus 704. An input/output (I/O) interface 705 is also connected to the bus 704.

The plurality of components in the device 700 are connected to the I/O interface 705, which include: an input unit 706, for example, a keyboard, a mouse; an output unit 707, for example, various types of displays, speakers; a storage unit 708, for example, a magnetic disk, an optical disk; and a communication unit 709, for example, a network card, a modem, a wireless transceiver. The communication unit 709 allows the device 700 to exchange information/data through a computer network such as Internet and/or various types of telecommunication networks with other devices.

The computing unit 701 may be various types of general and/or dedicated processing components with processing and computing abilities. Some examples of a computing unit 701 include but not limited to a central processing unit (CPU), a graphics processing unit (GPU), various dedicated artificial intelligence (AI) computing chips, various computing units on which a machine learning model algorithm is running, a digital signal processor (DSP), and any appropriate processor, controller, microcontroller, etc. The computing unit 701 executes various methods and processes as described above, for example, a method for training a text Q&A model or a method for text Q&A. For example, in some embodiments, the method for training a text Q&A model or the method for text Q&A may be further implemented as a computer software program, which is tangibly contained in a machine readable medium, such as the storage unit 708. In some embodiments, a part or all of the computer program may be loaded and/or installed on the device 700 via the ROM 702 and/or the communication unit 709. When the computer program is loaded on the RAM 703 and executed by the computing unit 701, one or more steps in the method for training a text Q&A model or the method for text Q&A may be performed as described above. Optionally, in other embodiments, the computing unit 701 may be configured to the method for training a text Q&A model or the method for text Q&A in other appropriate ways (for example, by virtue of a firmware).

Various implementations of the systems and techniques described above may be implemented by a digital electronic circuit system, an integrated circuit system, Field Programmable Gate Arrays (FPGAs), Application Specific Integrated Circuits (ASICs), Application Specific Standard Products (ASSPs), System on Chip (SOCs), Load programmable logic devices (CPLDs), computer hardware, firmware, software, and/or a combination thereof. These various embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

The program code configured to implement the method of the disclosure may be written in any combination of one or more programming languages. These program codes may be provided for the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in combination with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage media include electrical connections based on one or more wires, portable computer disks, hard disks, RAMs, ROMs, Electrically Programmable Read-Only-Memory (EPROM), fiber optics, Compact Disc Read-Only Memories (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user may provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein may be implemented in a computing system that includes background components (for example, a data server), or a computing system that includes middleware components (for example, an application server), or a computing system that includes front-end components (for example, a user computer with a graphical user interface or a web browser, through which the user may interact with the implementation of the systems and technologies described herein), or include such background components, intermediate computing components, or any combination of front-end components. The components of the system may be interconnected by any form or medium of digital data communication (e.g., a communication network). Examples of communication networks include: a Local Area Network (LAN), a Wide Area Network (WAN), and the Internet.

The computer system may include a client and a server. The client and server are generally remote from each other and interacting through a communication network. The client-server relation is generated by computer programs running on the respective computers and having a client-server relation with each other. The server may be a cloud server, a server of a distributed system, or a server combined with a block-chain.

It should be understood that the various forms of processes shown above may be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions may be made according to design requirements and other factors. Any modification, equivalent replacement and improvement made within the principle of the disclosure shall be included in the protection scope of the disclosure.

1. A computer-implemented method for training a text question and answer (Q&A) model, comprising:
determining a sample question text set and a sample answer text corresponding to a sample question text in the sample question text set;
inputting the sample question text into a text Q&A model to be trained, and obtaining a predicted answer text output by the text Q&A model and at least one prediction probability of at least one reference character on each character position in the predicted answer text;
determining an uncertainty degree of the predicted answer text based on the at least one prediction probability of at least one reference character on each character position in the predicted answer text; and
obtaining a trained text Q&A model by adjusting a parameter of the text Q&A model based on the sample answer text, the predicted answer text and the uncertainty degree of the predicted answer text.

2. The method of claim 1, further comprising:
inputting the sample question text in the sample question text set into the text Q&A model to be trained, and obtaining a plurality of candidate answer texts output by the text Q&A model;
determining a complexity degree of the sample question text based on the plurality of candidate answer texts; and
performing a filtration processing on each sample question text in the sample question text set based on the complexity degree of the sample question text in the sample question text set.

3. The method of claim 2, wherein determining the complexity degree of the sample question text comprises:
obtaining at least two clusters by clustering the plurality of candidate answer texts;
determining an occurrence probability of a candidate answer text in the at least two clusters; and
determining the complexity degree of the sample question text based on the occurrence probability of the candidate answer text in the at least two clusters.

4. The method of claim 3, wherein obtaining the at least two clusters by clustering the plurality of candidate answer texts comprises:
obtaining a plurality of answer text vectors for the plurality of candidate answer texts by vectorizing the plurality of candidate answer texts;
determining a similarity degree among the plurality of answer text vectors; and
obtaining the at least two clusters by clustering the plurality of candidate answer texts corresponding to the plurality of answer text vectors based on the similarity degree among the plurality of answer text vectors.

5. The method of claim 3, wherein determining the complexity degree of the sample question text based on the occurrence probability of the candidate answer text in the at least two clusters comprises:
for each cluster in the at least two clusters, determining a product result of a logarithm of the occurrence probability of the candidate answer text in the cluster and the occurrence probability of the candidate answer text in the cluster; and
obtaining the complexity degree of the sample question text by performing a sum operation and a NOT operation on each product result.

6. The method of claim 2, wherein performing the filtration processing on each sample question text in the sample question text set based on the complexity degree of the sample question text in the sample question text set comprises one of:
deleting, from the sample question text set, a sample question text with a complexity degree being less than or equal to a preset complexity degree threshold; or
obtaining a ranking result by ranking each sample question text in descending order based on the complexity degree of each sample question text; obtaining a preset number of first sample question texts that rank in the top of the ranking result; and filtering from the sample question text set, other sample question texts than the first sample question texts.

7. The method of claim 1, wherein determining the sample answer text corresponding to the sample question text in the sample question text set comprises:
for the sample question text in the sample question text set, obtaining an answer text output by a teacher text Q&A model by inputting the sample question text into the teacher text Q&A model; and
taking the answer text output by the teacher text Q&A model as the sample answer text corresponding to the sample question text.

8. The method of claim 1, wherein determining the uncertainty degree of the predicted answer text comprises:
for each character position in the predicted answer text, determining an uncertainty degree on the character position based on the at least one prediction probability of at least one reference character on the character position; and
obtaining the uncertainty degree of the predicted answer text by performing a sum operation and an averaging operation on the uncertainty degree on each character position in the predicted answer text.

9. The method of claim 8, wherein for each character position in the predicted answer text, determining the uncertainty degree on the character position comprises:
for each reference character on a character position in the predicted answer text, determining a product result of a logarithm of a prediction probability of the reference character and the prediction probability of the reference character; and
obtaining the uncertainty degree on the character position by performing a sum operation and a NOT operation on each product result.

10. The method of claim 1, wherein obtaining the trained text Q&A model comprises:
determining a first loss value based on the sample answer text, the predicted answer text and a loss function of the text Q&A model;
obtaining a second loss value by adjusting the first loss value based on the uncertainty degree of the predicted answer text; and
obtaining the trained text Q&A model by adjusting the parameter of the text Q&A model based on the second loss value.

11. The method of claim 10, wherein obtaining the second loss value comprises:
obtaining an adjustment coefficient by weighting the uncertainty degree of the predicted answer text with a preset coefficient and adding 1 to the uncertainty degree weighted; and
obtaining the second loss value by adjusting the first loss value based on the adjustment coefficient.

12. A method for a text question and answer (Q&A), comprising:
obtaining a question text to be processed;
inputting the question text into a text Q&A model and obtaining an answer text output by the text Q&A model, wherein the text Q&A model is determined based on the method for training a text Q&A model of claim 1; and
determining the answer text as an answer text corresponding to the question text.

13. An electronic device, comprising:
at least one processor; and
a memory connected in communication with the at least one processor,
wherein the at least one processor is configured to:
determine a sample question text set and a sample answer text corresponding to a sample question text in the sample question text set;
input the sample question text into a text Q&A model to be trained, and obtaining a predicted answer text output by the text Q&A model and at least one prediction probability of at least one reference character on each character position in the predicted answer text;
determine an uncertainty degree of the predicted answer text based on the at least one prediction probability of at least one reference character on each character position in the predicted answer text; and
obtain a trained text Q&A model by performing parameter adjustment on the text Q&A model based on the sample answer text, the predicted answer text and the uncertainty degree of the predicted answer text.

14. The electronic device of claim 13, wherein the at least one processor is further configured to:
input the sample question text in the sample question text set into the text Q&A model to be trained, and obtain a plurality of candidate answer texts output by the text Q&A model;
determine a complexity degree of the sample question text based on the plurality of candidate answer texts; and
perform a filtration processing on each sample question text in the sample question text set based on the complexity degree of the sample question text in the sample question text set.

15. The electronic device of claim 14, wherein the at least one processor is further configured to:
obtain at least two clusters by clustering the plurality of candidate answer texts;
determine an occurrence probability of a candidate answer text in the at least two clusters; and
determine the complexity degree of the sample question text based on the occurrence probability of the candidate answer text in the at least two clusters.

16. The electronic device of claim 15, wherein the at least one processor is further configured to:
obtain a plurality of answer text vectors for the plurality of candidate answer texts by vectorizing the plurality of candidate answer texts;
determine a similarity degree among the plurality of answer text vectors; and
obtain the at least two clusters by clustering the plurality of candidate answer texts corresponding to the plurality of answer text vectors based on the similarity degree among the plurality of answer text vectors.

17. The electronic device of claim 15, wherein the at least one processor is further configured to:
for each cluster in the at least two clusters, determine a product result of a logarithm of the occurrence probability of the candidate answer text in the cluster and the occurrence probability of the candidate answer text in the cluster; and
obtain the complexity degree of the sample question text by performing a sum operation and a NOT operation on each product result.

18. The electronic device of claim 14, wherein the at least one processor is further configured to:
delete, from the sample question text set, a sample question text with a complexity degree being less than or equal to a preset complexity degree threshold; or
obtain a ranking result by ranking each sample question text in descending order based on the complexity degree of each sample question text; obtain a preset number of first sample question texts that rank in the top of the ranking result; and filter from the sample question text set, other sample question texts than the first sample question texts.

19. The electronic device of claim 13, wherein the at least one processor is further configured to:
for the sample question text in the sample question text set, obtain an answer text output by a teacher text Q&A model by inputting the sample question text into the teacher text Q&A model; and
take the answer text output by the teacher text Q&A model as the sample answer text corresponding to the sample question text.

20. A non-transitory computer-readable storage medium for storing computer instructions, wherein the computer instructions are configured to cause a computer to implement a method for training a text question and answer (Q&A) model, the method comprising:
determining a sample question text set and a sample answer text corresponding to a sample question text in the sample question text set;
inputting the sample question text into a text Q&A model to be trained, and obtaining a predicted answer text output by the text Q&A model and at least one prediction probability of at least one reference character on each character position in the predicted answer text;
determining an uncertainty degree of the predicted answer text based on the at least one prediction probability of at least one reference character on each character position in the predicted answer text; and
obtaining a trained text Q&A model by performing parameter adjustment on the text Q&A model based on the sample answer text, the predicted answer text and the uncertainty degree of the predicted answer text.
